(19) United States
(12) Patent Application Publication
(10) Pub. No.: US 2006/0017708 A1
(43) Pub. Date: Jan. 26, 2006

(54) Input device

(76) Inventors: Toshiharu Fukui, Nara-shi (JP); Hisanori Kusunoki, Osaka-shi (JP); Akira Nakanishi, Hirakata-shi (JP); Tetsuo Murakami, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/133,272

(22) Filed: May 20, 2005

(30) Foreign Application Priority Data
Jul. 26, 2004 (JP) 2004-216771

(51) Int. Cl. G09G 5/00

(52) U.S. Cl. 345/173

(57) ABSTRACT

An input device is provided by piling up a plurality of touch panels in which an upper conductive layer of an upper substrate and a lower conductive layer of a lower substrate are disposed to oppose each other with a predetermined distance therebetween. Thus, inputting operations such as selection of a menu item or drawing of a character and determination of the item or character can be performed without tilting the input device downward but keeping it stationary and, hence, reliable actuation free from operating error can be attained.

### FIELD OF THE INVENTION

The present invention relates primarily to an input device used for operating various pieces of electronic equipment.

### BACKGROUND OF THE INVENTION

Advancements in performance and diversification in application of electronic apparatuses such as portable telephones and personal digital assistants are being made these days. Keeping pace with the advancements, devices having a light transmitting touch panel mounted on the front face of a display unit of a liquid crystal display (LCD) or the like and allowing functions of an apparatus to be switched over from one to another are increasing in number. In the above device, the switching between various functions is performed by user's pushing on the touch panel with a finger or pen while visually recognizing, through the touch panel, a display on the display unit behind the touch panel. Thus, there are demands for input devices that can be operated with ease and free of operating error.

An example of such input device is disclosed in Japanese Patent Unexamined Publication No. 2000-200141. This input device will be described with reference to FIG. 3. To make the configuration to be understood easily, dimension of the drawings in the direction through thickness are shown expanded.

FIG. 3 is a sectional view of the prior art input device, of which upper substrate 1 is in a film form and light transmittable and lower substrate 2 is made of glass or the like and light transmittable.

All over the bottom face of upper substrate 1, there is formed light transmitting upper conductive layer 3 made of such material as indium tin oxide (ITO) or the like, while all over the top face of lower substrate 2, there is formed light transmitting lower conductive layer 4 equally made of ITO or the like.

Further, on the top face of lower conductive layer 4, there are provided a plurality of dot spacers 5 made of an insulating resin disposed at a predetermined interval. Still further, on both front and back ends of upper conductive layer 3, there are disposed one pair of upper electrodes 3A. On both left and right ends of lower conductive layer 4, there are disposed one pair of lower electrodes 4A arranged orthogonally to upper electrodes 3A.

Further, upper substrate 1 and lower substrate 2 are stuck together at their peripheries by means of an adhesive layer (not shown) applied to top and bottom faces of spacer 6 in a picture-frame shape, so that upper conductive layer 3 and lower conductive layer 4 are arranged to oppose each other at a predetermined distance and thus a touch panel is provided.

The touch panel configured as described above is mounted on an electronic apparatus by being disposed in a tiltable manner on the front face of a LCD or the like of the apparatus. Further, the pair of upper electrodes 3A and lower electrodes 4A are connected to an electronic circuit (not shown) of the apparatus and, additionally, push switch 7 is disposed beneath the bottom face of lower substrate 2 and, thereby, an input device is provided.

With the input device configured as described above, if the top face of upper substrate 1 is pushed by the user with finger or pen 8, while a plurality of menu items or the like displayed on the LCD unit behind the touch panel are being visually recognized. Then, upper substrate 1 is bent at its pushed position so that upper conductive layer 3 is brought into contact with lower conductive layer 4.

Then, voltage from the electronic circuit is supplied sequentially to upper electrodes 3A and to lower electrodes 4A and the pushed position is detected by the electronic circuit based on the ratios of voltages between the electrodes. For instance, when pen or finger 8 kept pressed on the top face is moved to the left or right, the menu items or the like displayed on the LCD unit are scrolled to the left or right.

Then, if a stronger push with finger or pen 8 is given to the touch panel while a menu item to be selected is displayed, the touch panel is tilted downward, whereby push switch 7 pushed by the bottom face of lower substrate 2 is actuated to make electrical connection. This is detected by the electronic circuit and the selection of the menu item is determined.

The input device is further adapted to function such that, if a character or the like is drawn on the top face of upper substrate 1 with finger or pen 8 pressed against the top plate, and then a stronger push with finger or pen 8 is given to the top face after the drawing is finished, push switch 7 is depressed and this operation is detected by the electronic circuit and, thereby, the drawn character is determined and this character is displayed on the LCD unit.

In the above described conventional input device, however, the input device is disposed on an electronic apparatus with its touch panel arranged to be tiltable toward push switch 7 and it is adapted such that, when selection of a menu item or drawing of a character is finished, the touch panel is tilted downward to actuate push switch 7 thereby determining the menu item or the character. Accordingly, there has been a problem that an operating error of the push switch is liable to occur depending on the position on which the pushing force is exerted and hence it becomes difficult to perform a reliable inputting operation.

### SUMMARY OF THE INVENTION

The present invention provides an input device made up of a plurality of touch panels piled on top of another, each touch panel having an upper conductive layer on an upper substrate and a lower conductive layer on a lower substrate arranged to oppose each other at a predetermined distance. Hence, after a menu item has been selected or a character has been drawn on the upper touch panel, if a stronger push is given to the upper touch panel, the item or character is determined by the lower touch panel without the need for tilting the touch panel downward. Thus, an input device capable of making reliable actuation free from an operating error can be realized.

### BRIEF DESCRIPTION OF THE DRAWINGS

FIG. 1 is a sectional view of an input device according to an embodiment of the present invention.

FIG. 2 is a sectional view of an input device according to another embodiment of the present invention.

FIG. 3 is a sectional view of a conventional input device.

### DETAILED DESCRIPTION OF PREFERRED EMBODIMENTS

The present invention provides an input device made up of a plurality of touch panels piled on top of another, each touch panel having an upper conductive layer on an upper substrate and a lower conductive layer on a lower substrate, the conductive layers being arranged to oppose each other at a predetermined distance. Hence, after a menu item has been selected or a character has been drawn on the upper touch panel, if a stronger push is given to the upper touch panel, the item or character is determined by the lower touch panel without the need for tilting the touch panel downward. Thus, such an advantageous function can be obtained that an input device capable of a reliable actuation without producing an operating error can be provided.

The present invention further provides an input device having a plurality of dot spacers provided between the upper conductive layer and the lower conductive layer of each of a plurality of touch panels, in which the diameters of or intervals between the dot spacers in the upper touch panel and lower touch panel are made different. For example, the interval between the dot spacers in the upper touch panel is made larger than that in the lower touch panel. Thus, the actuating forces of the upper and lower touch panels are made distinctly different and therefore a more reliable actuation can be achieved.

The present invention further provides an input device made up of a plurality of touch panels in which an upper substrate and a lower substrate are given different thicknesses or made of different materials. Thus, various combinations of actuating forces can be realized.

The present invention further provides an input device in which an upper substrate and a lower substrate laid thereon are formed integral. Thus, number of component parts can be reduced and the input device can be manufactured at lower cost.

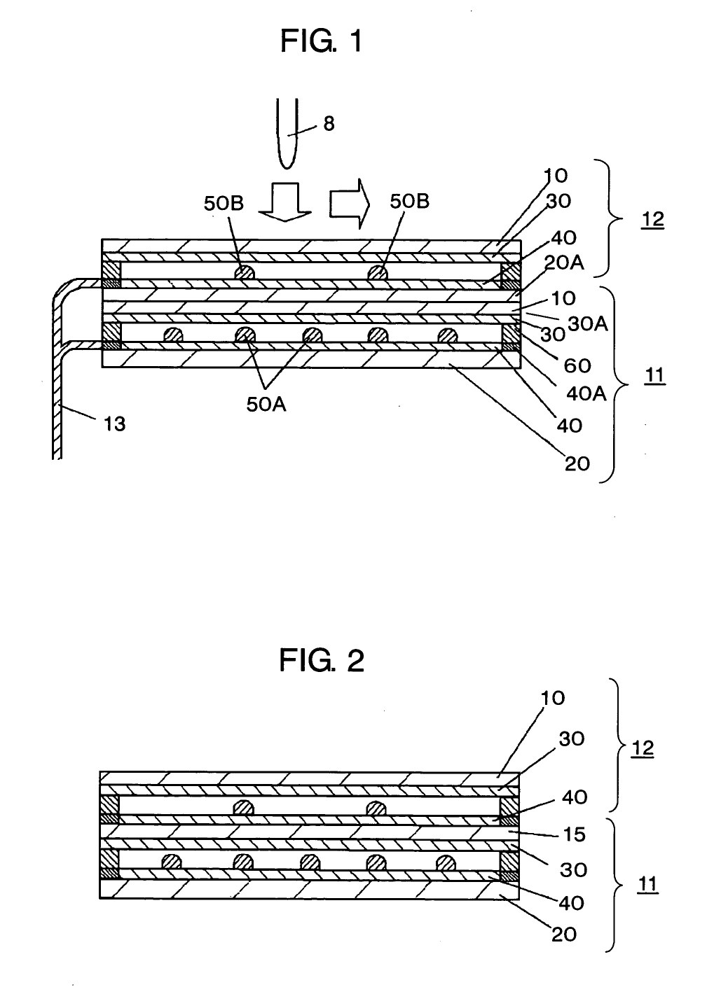

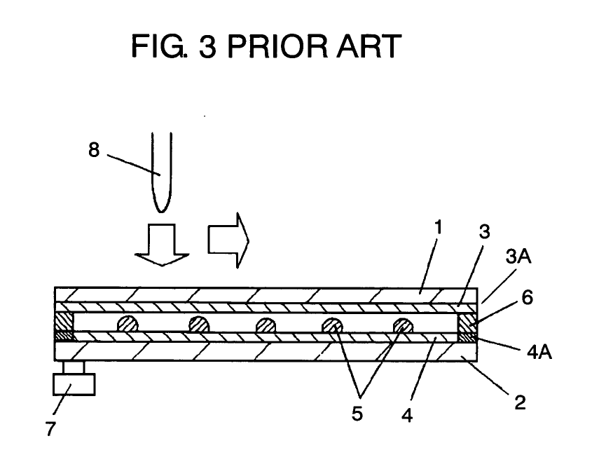

An embodiment of the present invention will be described below with reference to FIG. 1 and FIG. 2. Incidentally, dimensions in the direction through thickness are expanded in the drawings to facilitate understanding. Further, corresponding parts to those described in Background of the Invention are denoted by corresponding reference numerals and detailed description of the same is omitted.

(Exemplary Embodiment)

In FIG. 1, upper substrate 10 in a film form and light transmissive is made of polyethylene terephthalate (PET), polyether sulfone, polycarbonate (PC), norbornene resin, or the like.

Light-transmitting lower substrate 20 is similarly made of light-transmitting glass, acrylic resin, or the like. All over the bottom face of upper substrate 10, there is provided light-transmitting upper conductive layer 30 made of ITO, tin oxide, or the like, while all over the top face of lower substrate 20, there is provided similarly light-transmitting lower conductive layer 40, both layers being formed by sputtering or the like.

On the top face of lower conductive layer 40, there are disposed a plurality of dot spacers 50A made of such an insulating resin as epoxy resin or silicone resin at a predetermined interval. Further, at both front and rear ends of upper conductive layer 30, there are formed a pair of upper electrodes 30A. On both left and right ends of lower conductive layer 40, there are formed a pair of lower electrodes 40A orthogonally to upper electrodes 30A.

Further, adhesive layers (not shown) are applied to the top and bottom faces of spacer 60, in a picture-frame shape, made of nonwoven cloth, polyester film, or the like. The peripheries of upper substrate 10 and lower substrate 20 are stuck together by means of the adhesive layers so that upper conductive layer 30 and lower conductive layer 40 are arranged to oppose each other at a predetermined distance and thus touch panel 11 is constructed.

Further, a bottom face of lower substrate 20A, in a film form, of touch panel 12, which is similarly configured to touch panel 11, is attached to the top face of upper substrate 10 of touch panel 11 with an adhesive (not shown).

Meanwhile, the interval between a plurality of dot spacers 50B provided on the top face of lower substrate 20A of upper touch panel 12 is made larger than the interval between dot spacers 50A of lower touch panel 11.

On one or both of the top and bottom faces of wiring substrate 13 made of PET or PC in a film form, there are provided a plurality of wiring patterns formed of silver, carbon, copper foil, or the like. Each of the bifurcated ends of the same are connected to upper electrodes 30A and lower electrodes 40A of touch panels 11 and 12 and thus the input device is completed.

The input device configured as described above is mounted on an electronic apparatus by being installed on the front face of a LCD unit or the like of the apparatus. Meanwhile, the other end of wiring substrate 13 is connected to an electronic circuit (not shown) of the apparatus.

In use of the input device configured as described above, the user gives a push with finger or pen 8 to the top face of upper substrate 10 of upper touch panel 12 while visually recognizing a plurality of menu items or the like displayed on the LCD unit behind the input device. Then, upper touch panel 12 is bent and thereby the portion of upper conductive layer 30 under the push comes into contact with lower conductive layer 40.

Thereupon, a voltage is sequentially supplied from the electronic circuit to upper electrodes 30A and lower electrodes 40A through wiring substrate 13 so that the pushed position is detected by the electronic circuit depending on the voltage ratios between the electrodes. For instance, if finger or pen 8, while being pushed to the top face, is moved to the left or right, the menu items or the like displayed on the LCD are scrolled to the left or right.

If, finger or pen 8 is pushed more strongly while a menu item which the user desires to select is displayed, lower substrate 20A of upper touch panel 12 and upper substrate 10 of lower touch panel 11 are also bent, whereby upper conductive layer 30 of lower touch panel 11 is brought into contact with lower conductive layer 40. This is detected by the electronic circuit so that the selected menu item is determined.

Otherwise, when a character has been drawn on the top face with finger or pen 8 pushed to the top face of upper substrate 10, if in this state finger or pen 8 is pushed more strongly, an electrical connection is made in lower touch panel 11. The input device is so arranged that those operations are detected by the electronic circuit and thereby the drawn character is determined and the character is displayed on the LCD unit.

At this time, by having a stronger push given to upper touch panel 12 with the input device kept stationary after selection of a menu item or drawing of a character has been made, the selected menu item or drawn character can be determined by lower touch panel 11. Thus operating error of lower touch panel 11 seldom occurs and its reliable operation can be attained.

Further it is arranged such that the interval between the plurality of dot spacers 50B in upper touch panel 12 is larger than the interval between dot spacers 50A in lower touch panel 11. As a result, the force required for pushing down upper touch panel 12 and, additionally, lower touch panel 11 becomes greater than the force required for pushing down only upper touch panel 12. Thus, the forces required for actuating the upper and lower touch panels can be clearly distinguished by the feel and therefore more reliable operation can be attained.

According to the present embodiment as described above, by constructing the input device with a plurality of touch panels 11 and 12 piled up, it is made possible to perform input operation such as selection of a menu item or drawing of a character, and determination of such menu item or character without tilting the input device, i.e., with the input device kept stationary. Thus, an input device free from operating error and capable of reliable actuation can be realized.

Further, pluralities of dot spacers 50A and 50B are provided between upper conductive layer 30 and lower conductive layer 40 of touch panels 11 and 12 and intervals between the upper dot spacers and lower dot spacers are made different from each other. Thus, the operating forces of the upper and lower touch panels can be clearly distinguished by the feel and the more reliable operation can be attained.

In the above, a configuration in which the interval between dot spacers 50B in upper touch panel 12 is made larger than the interval between dot spacers 50A in lower touch panel 11 was described. Meanwhile, the interval between dot spacers 50B may be arranged to be smaller than the interval between dot spacers 50A, provided that the difference between operating forces of the upper panel and the lower panel is made clearly distinguishable.

Further, the operating forces of upper and lower touch panels may be made clearly distinguishable by making dot spacers in the upper and lower touch panels have different diameters, while disposing dot spacers 50A and 50B at the same intervals.

It is also possible to arrange such that dot spacers 50A and 50B have smaller interval and smaller diameter at the central position of the touch panel and have larger interval and larger diameter at the peripheral position. Thereby, the operating force is made different depending on whether the position is at the center or at the periphery,

In order to make the operating force different for upper touch panel 12 and lower touch panel 11, the thickness and material of upper substrate 10 and lower substrate 20, 20A may be varied. For example, the purpose is attained by giving upper substrate 10 a thickness of 75 μm and lower substrate 20A a thickness of 188 μm, or making upper substrate 10 of PET and lower substrate 20A of acrylic resin. By so doing, combination of various operating forces can be realized relatively easily, as compared with the case where intervals and diameters of dot spacers 50A and 50B are varied.

Further, touch panels 12 and 11 may be constructed by having an upper substrate 10 and a lower substrate 20A laid thereon (refer to FIG. 1) formed integral as shown in the sectional view of FIG. 2 and providing lower conductive layer 40 and upper conductive layer 30 on the top and bottom faces of intermediate substrate 15. Thereby, the number of component parts can be reduced and the input device can be manufactured at lower cost.

Such a configuration was described in the above that each of upper and lower touch panels 12 and 11 has a pair of upper electrodes 30A provided at both ends of upper conductive layer 30 and a pair of lower electrodes 40A provided at both ends of lower conductive layer 40 in the direction orthogonal to upper electrodes 30A, so that the pushed position of each touch panel is detected. However, in the case where lower touch panel 11 is used only for determination of a menu item or character, lower touch panel 11 may be provided with one each of upper electrode 30A and lower electrode 40A disposed only at one end of upper conductive layer 30 and lower conductive layer 40 so that lower touch panel 11 may be used not for detecting a position but simply for functioning as a switch contact.

Instead of piling up two touch panels, i.e., upper and lower touch panels 12 and 11, as described above, the present invention can be executed also by constructing an input device by piling up three or four touch panels.

Since the input device according to the present invention can provide reliable actuation free from operating error, it can be widely applied for actuating various electronic apparatuses.

What is claimed is:

1. An input device comprising a plurality of piled up touch panels,
each touch panel being made up of an upper substrate with an upper conductive layer formed on a bottom face thereof and a lower substrate with a lower conductive layer formed on a top face thereof, wherein
the upper conductive layer and the lower conductive layer are arranged to oppose each other with a predetermined distance therebetween.

2. The input device according to claim 1, wherein
one of the touch panels is actuatable with an operating force smaller than an operating force to actuate another touch panel laid beneath the same.

3. The input device according to claim 1, wherein a plurality of dot spacers are provided between the upper conductive layer and the lower conductive layer and the dot spacers in one of the touch panels and the dot spacers in another touch panel laid beneath the same have different diameters.

4. The input device according to claim 1, wherein a plurality of dot spacers are provided between the upper conductive layer and the lower conductive layer and the dot spacers in one of the touch panels and the dot spacers in another touch panel laid beneath the same are disposed at different intervals.

5. The input device according to claim 1, wherein the upper substrate and the lower substrate have different thicknesses.

6. The input device according to claim 1, wherein the upper substrate and the lower substrate are made of different materials.

7. The input device according to claim 1, wherein the lower substrate of one of the touch panels and the upper substrate of another touch panel laid beneath the same are formed integral.
